(19) United States
(12) Patent Application Publication
(10) Pub. No.: US 2021/0367490 A1
(43) Pub. Date: Nov. 25, 2021

(54) METHOD FOR PRODUCING A HELICAL ELECTRICALLY CONDUCTING BODY

(71) Applicant: Fraunhofer-Gesellschaft zur Förderung der angewandten Forschung e.V., München (DE)

(72) Inventors: Matthias BUSSE, Bremen (DE); Franz-Josef WÖSTMANN, Bremen (DE)

(21) Appl. No.: 17/045,971

(22) PCT Filed: Apr. 11, 2019
(86) PCT No.: PCT/EP2019/059351

§ 371 Date: Oct. 7, 2020

(30) Foreign Application Priority Data
Apr. 12, 2018 (DE) 10 2018 205 587.4

(51) Int. Cl. H02K 15/04; H02K 3/04; H02K 3/32; B22D 19/08; B22C 7/02; B22C 9/04

(52) U.S. Cl. CPC H02K 15/0435; H02K 3/04; B22C 9/046; B22D 19/08; B22C 7/02; H02K 3/32

(57) ABSTRACT

A method for producing a helical, electrically conducting body. The method including: producing a helical pattern as a lost mold made of a pattern material that can be at least one of liquefied and evaporated under the action of heat; covering the helical pattern with an insulating layer; embedding the helical pattern in foundry sand; pouring a metallic casting material into the lost mold, displacing the pattern material, and bonding with the insulating layer to form a cast body; and removing the cast body, together with the insulating layer adhering thereto, from the foundry sand.

### CROSS-REFERENCE TO RELATED APPLICATION

This application is a 371 National Stage Application of International Application No. PCT/EP2019/059351, filed 11 Apr. 2019, which claims priority to German Application No. 10 2018 205 587.4, filed 12 Apr. 2018, both of which are herein incorporated by reference in their entireties.

### TECHNICAL FIELD

The disclosure resides in the field of mechanical engineering and electrical engineering and can advantageously be used for electrical machines. However, a use is, in general, conceivable for all applications of electric coils. More specifically, the disclosure relates to a method for producing a helical electrically conducting body.

### BACKGROUND

Helical electrically conducting bodies are used in electrical machines as coils for generating magnetic fields or for other electrical purposes. Electric coils can, in general, be used in electrical installations. The favorable space utilization is an important parameter for the qualification of such coils for certain purposes. Different windings of a coil usually have a distance with respect to one another to prevent adjoining helical turns from making electrical contact. For manufacturing reasons, a certain minimum distance between adjoining helical turns is usually necessary for this purpose, so that the space utilization remains limited. In many instances, such helical electrically conducting bodies are also electrically insulated on the outer side thereof, so as to prevent electrical contacting.

Coils having a favorable space utilization have so far been produced, for example, as cast coils or coils produced by way of forming processes, for example as aluminum coils or copper coils. However, such coils are complex to produce. Applying an insulation to such a coil also necessitates complex work steps, in particular when the distance between adjoining helical turns/windings is small.

### SUMMARY

It is an object of the disclosure to create a method for producing a helical electrically conducting body, by which such bodies having a favorable space utilization are created with the least complexity possible. A favorable space utilization shall be understood to mean that the volume of the helix fills the overall volume to as high a degree as possible, so that as little volume as possible is lost between the individual turns of the helix or winding.

The disclosure thus relates, among other things, to a method for producing a helical, electrically conducting body, in which first a helical pattern is produced as a lost mold made of a pattern material that can be liquefied or evaporated under the action of heat, and thereafter is covered with an insulating layer, which in some embodiments is an electrically insulating layer, herein also referred to as a (preferably electrically) insulating layer and embedded in foundry sand, wherein thereafter a metallic casting material is poured into the lost mold, displacing the pattern material, and bonds with the insulating layer, and wherein the cast body is removed, together with the insulating layer adhering thereto, from the foundry sand.

In the described method, the helical, electrically conducting body is produced in a metal casting process using a lost mold. The lost mold is initially produced as a pattern in the shape desired for the end product, that is in helical form, thereafter is covered with a (preferably electrically) insulating layer, which later forms the conductor insulation of the coil or the outer insulation of the electrically conducting body, and adheres to the metal cast body when the lost mold is cast. The casting material and the material of the (preferably electrically) insulating layer are matched to one another such that the (preferably electrically) insulating layer adheres well to the cast part. The (preferably electrically) insulating layer is provided with a composition that qualifies it for the later use as the insulating layer of the coil.

The pattern thus coated is embedded into foundry sand, wherein foundry sand shall be understood to mean any deformable material suitable for lost mold casting for embedding of the pattern, that is, in particular materials in the form of granules and other fine-grained bulk materials.

After having been cast, the metal body is removed, together with the applied insulating layer, from the foundry sand and minimally cleaned, if at all, wherein, however, the insulating layer continues to adhere to the electrically conducting body. In addition to insulating the body, the insulating layer can also act as a separating layer with respect to the foundry sand. For this purpose, the insulating layer is preferably made of a material that achieves good separability of the foundry sand.

In embodiments of the method, it may be provided that the insulating layer is applied to the helical pattern in the form of a foundry coating.

In embodiments, it may be provided in this case that the foundry coating includes a carrier liquid, a refractory component, a binder, and optionally another additive.

The viscosity of the foundry coating is advantageously set in such a way that a suitable layer thickness can be applied onto the pattern. The layer is then first solidified by drying, setting or curing and, for this purpose, includes accordingly structured binders and/or additives. When solidified, the foundry coating has a strength that allows the metallic casting material to be poured in without damaging the layer in such a way that the casting material bonds with the layer. After the casting material has hardened, the layer then forms a surface coating that firmly adheres to the casting.

A further implementation of the method may provide that the insulating layer is deposited onto the helical pattern by way of dipping, squirting or spraying.

In embodiments, it may also be provided, for example, that the (preferably electrically) insulating layer is applied in the form of several consecutively applied sub-layers.

The different layers can be applied so as to build upon one another, and can each be at least partially solidified before the next layer is applied. However, it is also possible to solidify several layers together after the last layer has been applied.

In embodiments, it may be provided, for example, that the insulating layer is dried by heating and/or by way of an air current, either sub-layer by sub-layer or after the last layer has been applied. For example, the heating can also be achieved by infrared radiation.

The helical pattern can be cast or foamed entirely or in parts and, if necessary, be joined from parts. It can also be created from an extruded strand by deformation.

So as to produce the helical pattern, in embodiments, it may also be provided that the pattern is produced as a blank, and thereafter is brought into the shape of a helix by creating a helical recess. For this purpose, in embodiments, it may be provided, for example, that the helical recess is created in the blank by way of a tool that rotates about a first axis that extends through the blank, while being steadily advanced along the first axis. The first axis can be arranged inside a recess of the core, which extends completely through the core in the direction of the first axis. The core can be designed as a hollow cylinder, for example. However, it can also be designed as a cuboid having a continuous cylindrical recess.

So as to achieve an abrasive or cutting action of the tool, in embodiments, it may be provided that the tool has a strand-shaped, and in particular rod-shaped, design and rotates about a second axis, in particular its own longitudinal axis, during the creation of the helical recess, or carries out an oscillating movement along the second axis, wherein the tool includes, in particular, saw-like or rasp-like teeth. In this way, the tool can be moved helically through the entire blank and introduce a helical recess therein. The remaining portion of the blank then likewise has the shape of a helix and forms the pattern for the subsequent lost mold metal casting process.

Instead of or in addition to the abrasive action of the tool, in embodiments, it may be provided that the tool is heated to a temperature at which the material of the pattern at least softens, and in particular melts. The tool then acts as a hot cutting wire and, similarly to a rasp-like tool, can create a helical recess in the blank/core.

The method according to the invention is suitable both for coating with electrically insulating layers and with not necessarily electrically insulating layers, that is, layers that, for example, are provided for corrosion prevention/corrosion reduction or for other insulating purposes.

In principle, coating materials similar to those used in subsequent coating processes can be resorted to when selecting the coating materials. For the claimed subject matter, however, the details described hereafter have also proven to be advantageous: For example, the material of the insulating layer can comprise a plastic material (also provided with corresponding electrically insulating or electrically non-insulating additives). Depending on the application, ceramic materials are also used for the insulating coating.

In embodiments, specific examples of materials for the insulating layer are: thermoplastic polyurethanes, thermoplastic polycarbonates and/or polymethyl methacrylate.

It has also been shown that materials used for traditional powder coating and/or powder lacquering can be resorted to, which can also be processable in liquid solution.

In embodiments, it has been shown that polyamide, polyvinyl chloride, epoxy systems including polyester as a binder, polyester systems including TGIC as a hardener and/or acrylate and/or polyurethane systems can thus also be included as materials.

The method according to the disclosure is thus a suitable choice, in particular also for the production of helical bodies or helices or spiral-shaped bodies, and in particular also for the use in electrical machines, and there on a large-scale use. These have the feature that a metallic base material and an insulating layer adhering thereto are present.

In embodiments, copper and aluminum, for example, are a suitable choice as casting materials.

Depending on the application of the helical body, for example in an electrical machine to be assembled later, the geometry and size of the helical body may differ. It is not mandatory that always spiral-shaped helices having a uniform winding cross-section and a uniform cylindrical inner and outer contour are involved; for example, both changes in the cross-sectional surface area, the cross-sectional shape and/or the overall body and changes of the individual winding over the progression thereof are possible. It is possible, for example, for the body to have a longitudinal axis (axis in the direction of the largest extension of the body), and for the largest extension of the body perpendicular to this longitudinal axis to be between 0.02 m and 2 m. For example, the largest extension perpendicular to this longitudinal axis of a body produced by investment casting can be between 0.02 m and 1 m, and that of a body produced in a lost foam process can be between 0.2 m and 2 m.

The body can also include windings, wherein the largest cross-sectional extension perpendicular to the progression of a winding is between 0.2 mm and 5 cm, and preferably between 0.7 mm and 2 cm. For example, the largest extension perpendicular to the progression of a winding of a body produced by investment casting can be between 0.2 mm and 1 cm, and that of a body produced in a lost foam process can be between 3 mm and 5 cm.

For example, bodies produced by the method which comprise copper, aluminum, silver or magnesium as the metallic material, and an insulating layer made of plastic material or a ceramic insulating material, and which, for example, have a circular or elliptical or polygonal or rounded polygonal shape are a suitable choice.

Moreover, bodies produced by the method can also comprise other metals, or metal alloys, as the metallic material, or can also comprise other electrically conductive materials as the metallic material. In this way, the casting properties and mechanical properties can be adapted to the technical requirements, and the economic requirements can be taken into account.

### BRIEF DESCRIPTION OF THE DRAWINGS

The invention will be shown and described hereafter based on figures of an exemplary embodiment. In the drawings:

FIG. 1 shows a perspective view of a rectangular coil, according to embodiments of the disclosure;

FIG. 2 shows a perspective view of a strand section of a helical pattern, according to embodiments of the disclosure;

FIG. 3 shows a pattern as in FIG. 2, additionally comprising a first coating, according to embodiments of the disclosure;

FIG. 4 shows a pattern comprising a coating composed of two layers, according to embodiments of the disclosure;

FIG. 5 shows the coating of a pattern after the pattern has been removed, according to embodiments of the disclosure;

FIG. 6 shows a metallic cast body comprising a coating, according to embodiments of the disclosure;

FIG. 7 schematically shows a pattern in a perspective view and a device for producing the pattern, according to embodiments of the disclosure; and

FIG. 8 schematically shows the representation of a procedure for producing a helical, electrically conducting body, according to embodiments of the disclosure.

### DETAILED DESCRIPTION

FIG. 1 shows a perspective view of a helical electrically conducting body in the form of a rectangular coil 1, which consists of a helical, strand-shaped body 2 having a rectangular cross-section, or comprises such a strand-shaped body. As an alternative thereto, in embodiments, helical bodies can be produced, for example, as coils twisted in a screw-like manner in a circular shape, or also as coils wound in a spiral-shaped manner or in other similar shapes. Such a body can be produced by way of lost mold metal casting.

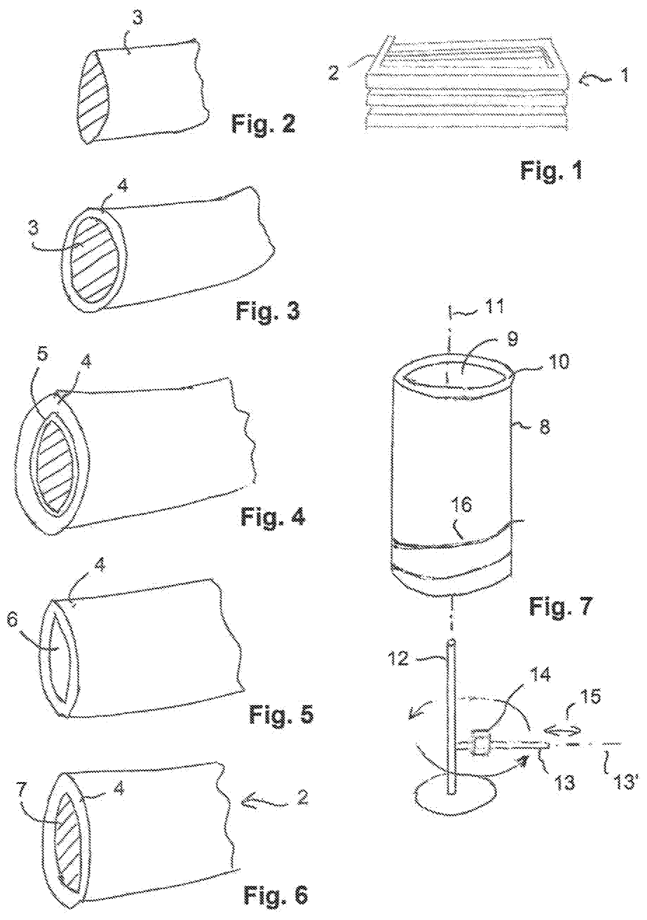

FIG. 2 shows a short section of a strand-shaped pattern 3, which can be configured as a helical body having a circular cross-section. Such a pattern can, for example, be produced as a foamed plastic body, or also in the form of a wax. Such a pattern, or a pattern body, is used as a lost mold, which means that it is placed into a flask including foundry sand, wherein molten metal is poured into the volume of the pattern body, thereby dissolving the material of the pattern body by liquefaction or evaporation and displacing it.

Some embodiments, provide such patterns/pattern bodies with a coating to seal the possibly rough or porous surface of the pattern, and facilitate later demolding of the cast body from the foundry sand as well as the removal of the foundry sand stuck to the cast body.

FIG. 3 shows a perspective view of the strand-shaped pattern from FIG. 2, comprising a first layer 4 that surrounds the pattern and covers the lateral surface of the pattern and that is composed of an electrically insulating and/or an anti-corrosive insulating material.

To prepare for casting, the pattern 3 is embedded with the layer 4 in foundry sand, and the molten metal is poured into the lost mold thus configured. The layer 4, which is considerably more temperature-resistant than the material of the pattern 3, remains adhering to the surface of the cast body.

Coatings for the improved separation of the cast body from the foundry sand are known from the related art, which are removed from the cast body after the casting process. In contrast, the layer 4 described here is very stable and configured so as to adhere well to the cast body. It does not need to be removed from the cast body after the cast body has been removed from the foundry sand and, rather, can remain on the cast body, serving as an insulating layer. In this way, the need to provide the cast body later with an electrically insulating layer is eliminated.

FIG. 4 represents a variant in which the pattern body 3 is initially provided with an adhesion promoter layer 5, and only thereafter is coated with a layer 4 made of an insulating material. The adhesion promoter 5 is composed of a material that adheres well to the cast body on the one hand, and to the insulating layer 4 on the other hand. The adhesion promoter 5 is configured so as not to be destroyed when molten metal is poured in, but adheres to the metal cast body. The adhesion promoter can be made of an electrically insulating or also of an electrically conducting material. For example, the adhesion promoter can also be made of a metal that melts at the melting temperature of the metal to be cast. This metal of the adhesion promoter can be applied to the pattern in powder form, for example.

FIG. 5 schematically shows only the layer 4, from which the pattern body has been removed by way of evaporation or liquefaction, so that the molten metal flows into the space 6 surrounded by the layer 4.

FIG. 6 represents the cast body 7 to which the layer 4 firmly adheres, serving as an insulating layer.

The coating of the pattern body 3 with the layer 4 is carried out by applying a viscous, liquid or mash-like mass, for example in the form of a foundry coating comprising a carrier liquid, which can be water or alcohol, for example, and one or more refractory components, as well as optionally additives that set the viscosity. After the metal casting process, the layer 4 at least still contains the refractory components and optionally also binders, and together these form the insulating layer.

The coating 4 can also be achieved in multiple stages in liquid form, wherein individual layers set, or are dried or cured in between. In this way, overall larger layer thicknesses can be created in a short time.

For example, the pattern body 3 can be produced by foaming in a mold, or by casting or core shooting. Depending on the complexity, it may also be composed of multiple pieces, both of individual foamed sub-bodies and of individual cast sub-bodies.

One option for production is, for example, that a helical recess is cut out of a continuous, for example cylindrical or prismatic body, whereby a helical body remains. Such a variant is shown in FIG. 7 by way of example. A hollow cylinder 8 comprising a hollow cylinder wall 10 is shown there, which surrounds a cavity 9. A shaft 12 of a cutting device is inserted into the cavity 9 along the cylinder axis 11, wherein a tool 13 is arranged on the shaft 12, projecting radially therefrom. The tool 13 can be configured as a saw-like or rasp-like strand-shaped tool, which can be driven in a vibrating or oscillating manner, for example, by an oscillating drive 14 in the radial direction with respect to the axis 11. When the tool 13 is pivoted about the shaft 12 by rotating the same, on the one hand, and evenly and steadily advanced along the axis 11 by a further drive, on the other hand, the tool 13 follows a helical path, by which a helical recess 16 can be introduced into the hollow cylinder 8. When the helical recess 16 extends through the body of the hollow cylinder 8, a helical body of the pattern remains between the individual turns of the recess 16, which can then be coated with a layer 4 or a combined layer 4, 5. Thereafter, the pattern body thus created can serve as a lost mold for metal casting using molten metal, resulting in a round metal coil comprising an insulating coating.

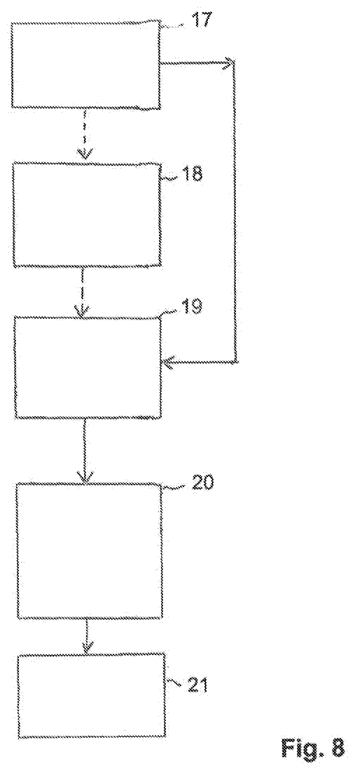

Based on process steps, FIG. 8 schematically illustrates the production of a helical, electrically conducting body that is provided with an insulation.

In a first method step 17, the pattern body is produced from a foam or a wax. Thereafter, an adhesion promoter 5 is optionally applied to the pattern in a subsequent step 18. In the next method step 19, an insulating layer 4, for example in the form of a foundry coating, is applied either directly to the pattern or to the adhesion promoter layer and is allowed to set.

The lost mold thus created is placed in foundry sand in the following process step 20, and is filled with molten metal in process step 21. In this way, the conducting body comprising the insulating layer is completed.

1.-25.(canceled)

26. A method for producing a helical, electrically conducting body, the method comprising:
producing a helical pattern as a lost mold made of a pattern material that can be at least one of liquefied and evaporated under the action of heat;
covering the helical pattern with an insulating layer;
embedding the helical pattern in foundry sand;
pouring a metallic casting material into the lost mold, displacing the pattern material, and bonding with the insulating layer to form a cast body; and
removing the cast body, together with the insulating layer adhering thereto, from the foundry sand.

27. The method of claim 26, wherein the insulating layer is applied to the helical pattern in the form of a foundry coating.

28. The method of claim 27, wherein the foundry coating includes a carrier liquid, a refractory component, and a binder.

29. The method of claim 26, wherein the insulating layer is applied to the helical pattern by way of at least one of dipping, squirting, and spraying.

30. The method of claim 26, wherein the insulating layer is deposited in the form of several consecutively applied sub-layers.

31. The method of claim 26, wherein the insulating layer is dried by one or more of heating and an air current, either sub-layer by sub-layer or after the last layer has been deposited.

32. The method of claim 26, wherein the helical pattern is produced in one of a casting process and a foaming process, the helical pattern being assembled from multiple parts.

33. The method of claim 32, wherein the helical pattern is produced as a blank, and thereafter is brought into the shape of a helix by creating a helical recess.

34. The method of claim 33, wherein the helical recess is created in the blank by way of a tool rotating about a first axis, which extends through the blank, while being steadily advanced along the first axis.

35. The method of claim 34, wherein the tool has a strand-shaped design, and during the creation of the helical recess, the tool does one of rotates about a second axis or carries out an oscillating movement along the second axis, the tool including at least one of saw-like and rasp-like teeth.

36. The method of claim 34, wherein the tool is heated to a temperature at which the material of the helical pattern softens or melts.

37. The method of claim 26, wherein material of the insulating layer is electrically insulating.

38. The method of claim 26, wherein material of the insulating layer is configured to be anti-corrosive.

39. The method of claim 26, wherein material of the insulating layer comprises a plastic material.

40. The method of claim 26, wherein material of the insulating layer comprises a ceramic material.

41. The method of claim 26, wherein material of the insulating layer comprises one or more of thermoplastic polyurethanes, thermoplastic polycarbonates, and polymethyl methacrylate.

42. The method of claim 26, wherein material of the insulating layer comprises one or more of material for powder coating and material for powder lacquering.

43. The method of claim 26, wherein material of the insulating layer comprises one or more of a polyamide, polyvinyl chloride, epoxy systems including polyester as a binder, polyester systems including TGIC as a hardener, acrylate, and polyurethane systems.

44. A helical body, produced in the method of claim 26 and including the metallic casting material and the insulating layer adhering thereto.

45. The helical body of claim 44, wherein the metallic casting material includes at least one of copper and aluminum.

46. The helical body of claim 44, wherein the insulating layer includes at least one of ceramic material and plastic material.

47. The helical body of claim 44, wherein the helical body has a longitudinal axis and a largest extension perpendicular to the longitudinal axis is between 0.02 m and 2 m.

48. The helical body of claim 44, wherein the helical body includes windings, and a largest cross-sectional extension perpendicular to a progression of at least one winding is between 0.3 mm and 5 cm.

49. The helical body of claim 44, wherein the metallic casting material includes one or more of copper, aluminum, silver, and magnesium and the insulating layer includes an insulating plastic material.

50. The helical body of claim 44, wherein the metallic casting material includes one or more of copper, aluminum, silver, and magnesium and the insulating layer includes a ceramic insulating material.
